(19) United States
(12) Patent Application Publication
(10) Pub. No.: US 2013/0262788 A1
(43) Pub. Date: Oct. 3, 2013

(54) Systems and Methods for External Priority Controlled Data Transfer

(71) Applicants: Fan Zhang, Milpitas, CA (US); Shaohua Yang, San Jose, CA (US); Douglas M. Hamilton, Littleton, CO (US)

(72) Inventors: Fan Zhang, Milpitas, CA (US); Shaohua Yang, San Jose, CA (US); Douglas M. Hamilton, Littleton, CO (US)

(73) Assignee: LSI Corporation

(21) Appl. No.: 13/433,693

(22) Filed: Mar. 29, 2012

(51) Int. Cl. G06F 12/00

(52) U.S. Cl. 711/151; 711/E12.001

(57) ABSTRACT

The present inventions are related to systems and methods for data processing, and more particularly to systems and methods for priority based data processing. As an example a system is discussed that includes a data transfer controller circuit operable to provide a read request to a storage device. The read request indicates a data set to be provided from the storage device and a processing priority of at least a portion of the data set.

### BACKGROUND OF THE INVENTION

The present inventions are related to systems and methods for data processing, and more particularly to systems and methods for priority based data processing.

Various data transfer systems have been developed including storage systems, cellular telephone systems, and radio transmission systems. In each of the systems data is transferred from a sender to a receiver via some medium. For example, in a storage system, data is sent from a sender (i.e., a write function) to a receiver (i.e., a read function) via a storage medium. In some cases, the data processing function uses a variable number of iterations through a data detector circuit and/or data decoder circuit depending upon the characteristics of the data being processed. Each data set is given equal priority until a given data set concludes either without errors in which case it is reported, or concludes with errors in which case a retry condition may be triggered. In such a situation processing latency is generally predictable, but is often unacceptably large.

Hence, for at least the aforementioned reasons, there exists a need in the art for advanced systems and methods for data processing.

### BRIEF SUMMARY OF THE INVENTION

The present inventions are related to systems and methods for data processing, and more particularly to systems and methods for priority based data processing.

Various embodiments of the present invention provide systems that include a data transfer controller circuit operable to provide a read request to a storage device. The read request indicates a data set to be provided from the storage device and a processing priority of at least a portion of the data set. In some instances of the aforementioned embodiments, the processing priority indicates two or more priorities including a high priority processing, and a low priority processing. In various instances of the aforementioned embodiments, the processing priority is selected based upon a type of data included in the portion of the data set.

In some particular instances of the aforementioned embodiments where the processing priority indicates at least at high or low priority processing, the processing priority is selected as the low priority processing when the portion of the data set is a first data type that is resilient to errors, and the processing priority is selected as the high priority processing when the portion of the data set is a second data type that is not resilient to errors. In other particular instances of the aforementioned embodiments where the processing priority indicates at least at high or low priority processing, the processing priority is selected as the high priority processing when the portion of the data set is of primary importance to the read request; and the processing priority is selected as the low priority processing when the portion of the data set is of secondary importance to the read request. In some instances of the aforementioned embodiments, the data transfer controller circuit is implemented as part of a microprocessor based system including a microprocessor and a memory. In such instances, the memory includes instructions executable by the microprocessor to assign the processing priority. In some cases, the microprocessor based system further includes a priority data map operable to store the assigned processing priority in relation to the portion of the data set.

In various instances of the aforementioned embodiments where the data transfer controller circuit is a memory access controller circuit, the portion of the data set is a first portion of the data set, and the processing priority is a first processing priority, the system further includes the storage device having a storage medium and a data processing circuit. The data processing circuit includes: an input buffer operable to maintain a first portion of the data set and a second portion of the data set that is associated with a second processing priority; a data detector circuit operable to apply a data detection algorithm to a selected data set to yield a detected output; and an external priority indication based scheduler circuit. The external priority indication based scheduler circuit is operable to: receive the first processing priority and the second processing priority; and select the first data set as the selected data set based at least in part on the first processing priority being higher than the second processing priority.

Other embodiments of the present invention provide systems that include a data write controller circuit operable to provide a send request to a communication device. The send request indicates a data set to be communicated by the communication device and a processing priority of at least a portion of the data set. n some instances of the aforementioned embodiments, the processing priority indicates two or more priorities including a high priority processing, and a low priority processing. In various instances of the aforementioned embodiments, the processing priority is selected based upon a type of data included in the portion of the data set.

In some instances of the aforementioned embodiments where the processing priority indicates two or more possible priorities including a high priority and a low priority, the processing priority is selected as the low priority processing when the portion of the data set is a first data type that is resilient to errors; and the processing priority is selected as the high priority processing when the portion of the data set is a second data type that is not resilient to errors. In some cases, the data write controller circuit is implemented as part of a microprocessor based system including a microprocessor and a memory. In such instances, the memory includes instructions executable by the microprocessor to assign the processing priority.

In various instances of the aforementioned embodiments where the data set is a send data set, the system further includes the communication device having a transmitter and a receiver. The receiver includes a data processing circuit that includes: an input buffer operable to maintain a first received data set and a second received data set; a data detector circuit operable to apply a data detection algorithm to a selected data set to yield a detected output; an external priority indication based scheduler circuit. The external priority indication based scheduler circuit is operable to: receive a first processing priority associated with the first received data set, and a second processing priority associated with the second received data set; and select the first received data set as the selected data set based at least in part on the first processing priority being higher than the second processing priority.

Yet other embodiments of the present invention provide methods for transferring data that include: receiving a request to access information that identifies a block of data to be accessed; identifying a processing priority associated with at least a portion of the block of data; and providing a transfer command that identifies the block of data and the processing priority. In some instances of the aforementioned embodiments, the processing priority indicates one of a high priority processing or a low priority processing. In some such instances, the processing priority is selected as the low priority processing when the portion of the block of data set is a first data type that is resilient to errors; and the processing priority is selected as the high priority processing when the portion of the block of data is a second data type that is not resilient to errors. In other such instances, the processing priority is selected as the high priority processing when the portion of the block of data is of primary importance to the request to access information, and wherein the processing priority is selected as the low priority processing when the portion of the block of data of secondary importance to the request to access information. In various instances of the aforementioned embodiments, identifying the processing priority associated with at least a portion of the block of data includes accessing a priority data map operable to store the assigned processing priority in relation to the portion of the block of data.

Further embodiments of the present invention provide methods for transferring data that include: receiving a request to send information, where the request provides a block of data to be sent and indicates a type of data to be sent; identifying a processing priority associated with the type of data to be sent; and providing a send data set that includes the block of data to be sent and the processing priority.

Various other embodiments of the present invention provide data processing systems that include an input buffer, a data detector circuit, and an external priority indication based scheduler circuit. The input buffer is operable to maintain at least a first data set and a second data set. The data detector circuit is operable to apply a data detection algorithm to a selected data set to yield a detected output. The external priority indication based scheduler circuit operable to: receive a first priority associated with the first data set and a second priority associated with the second data set; and select the first data set as the selected data set based at least in part on the first priority being higher than the second priority. In some cases, the data detector circuit may be a Viterbi algorithm data detector circuit, or a maximum a posteriori data detector circuit. In some instances of the aforementioned embodiments, the system is implemented as an integrated circuit. In various cases, the data processing system is incorporated in a storage device, or a data transmission device. In one or more instances of the aforementioned embodiments, the system further includes a host controller, and the first priority and the second priority are received from the controller. In some instances, a request for a first data output corresponding to the first data set is received from the host controller, and a request for a second data output corresponding to the first data set is received from the host controller.

In some instances of the aforementioned embodiments, the external priority indication based scheduler circuit is further operable to select the one of the first data set and the second data set that has been in the input buffer the longest based at least in part on the first priority being the same as the second priority. In various instances of the aforementioned embodiments, the detected output is a first detected output, and the data processing system further includes a central memory and a data decoder circuit. The central memory is operable to store a first decoder input derived from the first detected output and a second decoder input derived from the second detected output, wherein the second decoder input is associated with a third priority. The data decoder circuit is operable to apply a data decode algorithm to a selected input derived from the detected output to yield a decoded output. In such instances, the external priority indication based scheduler circuit is further operable to select the first decoder input as the selected input based at least in part on the first priority being higher than the third priority. In some cases, the external priority indication based scheduler circuit is further operable to select the one of the first decoder input and the second decoder input that corresponds to a data set that has been in the input buffer the longest based at least in part on the first priority being the same as the third priority. In particular cases, the data decoder circuit is a low density parity check decoder circuit.

Other embodiments of the present invention provide data processing systems that include an input buffer, a data detector circuit, a data decoder circuit, a central memory circuit, and an external priority indication based scheduler circuit. The input buffer is operable to maintain at least a first data set, a second data set, and a third data set. The data detector circuit is operable to apply a data detection algorithm to a selected data set to yield a detected output, and the data decoder circuit is operable to apply a data decode algorithm to a decoder input derived from the detected output to yield a corresponding decoded output. The central memory circuit is operable to maintain at least the first decoded output corresponding to the first data set, and a second decoded output corresponding to the second data set. An external priority indication based scheduler circuit is operable to: receive a first priority associated with the first data set, a second priority associated with the second data set, and a third priority associated with the third data set; and select one of the first data set, the second data set and the third data set as the selected data set based at least in part on one of the first priority, the second priority, and the third priority. In some cases, the system further includes a host controller that provides the first priority, the second priority, and the third priority. In particular cases, a request for a first data output corresponding to the first data set is received from the host controller, a request for a second data output corresponding to the first data set is received from the host controller, and a request for a third data output corresponding to the third data set is received from the host controller.

In various instances of the aforementioned embodiments, the corresponding decoded output is a third decoded output, and selecting one of the first data set, the second data set and the third data set as the selected data set includes selecting the third data set as the selected data set based at least in part on the third priority being greater than the second priority and the third priority being greater than the first priority. In some such instances, the external priority indication based scheduler circuit is further operable to remove the one of the first data set and the second data set from the input buffer that has been in the input buffer the longest regardless of convergence of the first decoded output and the second decoded output. In other instances of the aforementioned embodiments, the corresponding decoded output is the first decoded output, and selecting one of the first data set, the second data set and the third data set as the selected data set includes selecting the first data set as the selected data set based at least in part on the first priority being greater than the second priority and the first priority being greater than the third priority. In yet other instances of the aforementioned embodiments, the corresponding decoded output is a selected one of the first decoded output and the second decoded output, and selecting one of the first data set, the second data set and the third data set as the selected data set includes selecting one of the first data set and the second data set as the selected data set based at least in part on the first priority being the same as the second priority, and the first priority being greater than or equal to the third priority.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 shows a storage system including external priority indication based priority scheduler circuitry in accordance with various embodiments of the present invention;

FIG. 2 depicts a data transmission system including external priority indication based priority scheduler circuitry in accordance with one or more embodiments of the present invention;

FIG. 3 shows a data processing circuit including an external priority indication based priority scheduler circuit in accordance with some embodiments of the present invention;

FIGS. 4a-4b are flow diagrams showing a method for external priority indication based priority data processing in accordance with some embodiments of the present invention;

FIGS. 5a-5b are flow diagrams showing another method for external priority indication based priority data processing in accordance with other embodiments of the present invention;

FIGS. 6a-6b are flow diagrams showing yet another method for external priority indication based priority data processing in accordance with yet other embodiments of the present invention;

FIG. 7 is an application device including a microprocessor based system operable to access a storage device using priority based access commands in accordance with some embodiments of the present invention;

FIG. 8 shows another application device including a microprocessor based system operable to transfer information to a communication device using priority based access commands in accordance with various embodiments of the present invention;

FIG. 9 is a flow diagram showing a method for priority based access to a storage device in accordance with one or more embodiments of the present invention; and

FIG. 10 is a flow diagram showing a method for priority based access to a data transfer device in accordance with some embodiments of the present invention.

### DETAILED DESCRIPTION OF THE INVENTION

The present inventions are related to systems and methods for data processing, and more particularly to systems and methods for priority based data processing.

Various embodiments of the present invention provide for data processing that includes prioritizing processing data sets based upon an externally provided priority indicator. Such a priority indicator may be received, for example, from a host device requesting data from a storage device or from a host device directing transmission of data from a transmission device. Based upon the disclosure provided herein, one of ordinary skill in the art will recognize a variety of sources of the externally provided priority indicator. As an example, a data processing system having an external priority indication based priority scheduler circuit may include a data decoder circuit and a data detector circuit. When selecting a data set for processing by the data decoder circuit and/or the data detector circuit, the priority indicated in relation to different data sets being concurrently processed is considered. Such an approach assures that more processing cycles are made available for higher priority data sets when compared with the lower priority data sets. This increases the likelihood that higher priority data will converge.

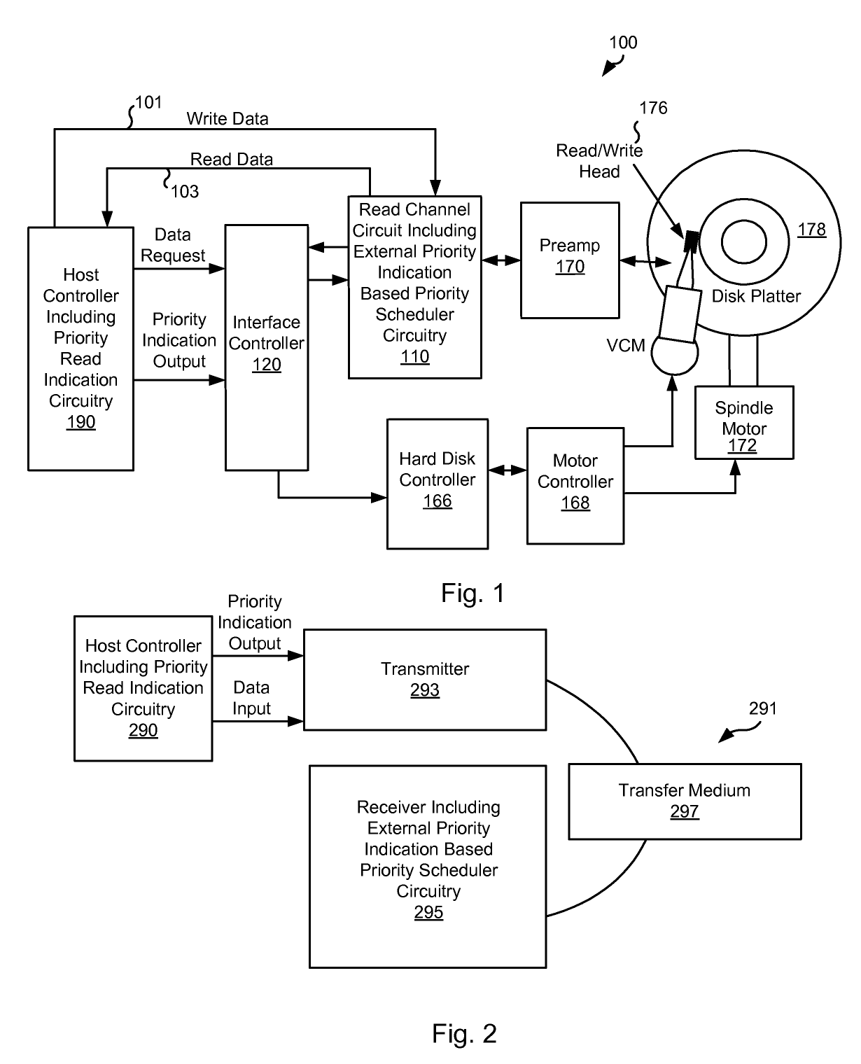

Turning to FIG. 1, a storage system 100 including a read channel circuit 110 having external priority indication based priority scheduler circuitry is shown in accordance with various embodiments of the present invention. Storage system 100 may be, for example, a hard disk drive. Storage system 100 also includes a preamplifier 170, an interface controller 120, a hard disk controller 166, a motor controller 168, a spindle motor 172, a disk platter 178, and a read/write head 176. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

Storage system 100 is accessed based upon instructions received from a host controller 190. Host controller 190 includes priority read indication circuitry operable to indicate that one or more requested data sets are of a higher priority that one or more other requested data sets. In a typical read operation, host controller 190 provides a data request and a priority indication output to interface controller 120. The data request indicates a block of data that is requested to be provided back to host controller 190 as a read data 103, and the priority indication output indicates one or more data sets within the block of requested data are of a higher priority that one or more other requested data sets.

In response to the request received from host controller 190, read/write head assembly 176 is accurately positioned by motor controller 168 over a desired data track on disk platter 178. Motor controller 168 both positions read/write head assembly 176 in relation to disk platter 178 and drives spindle motor 172 by moving read/write head assembly to the proper data track on disk platter 178 under the direction of hard disk controller 166. Spindle motor 172 spins disk platter 178 at a determined spin rate (RPMs). Once read/write head assembly 176 is positioned adjacent the proper data track, magnetic signals representing data on disk platter 178 are sensed by read/write head assembly 176 as disk platter 178 is rotated by spindle motor 172. The sensed magnetic signals are provided as a continuous, minute analog signal representative of the magnetic data on disk platter 178. This minute analog signal is transferred from read/write head assembly 176 to read channel circuit 110 via preamplifier 170. Preamplifier 170 is operable to amplify the minute analog signals accessed from disk platter 178. In turn, read channel circuit 110 decodes and digitizes the received analog signal to recreate the information originally written to disk platter 178. This data is provided as read data 103 to host controller 190. A write operation is different in that host controller 190 provides write data 190 to read channel circuit 110 that proceeds to encode and write the data to disk platter 178 using hard disk controller 166, motor controller 168, read/write head assembly 176, and spindle motor 172 to effectuate the write to the desired location.

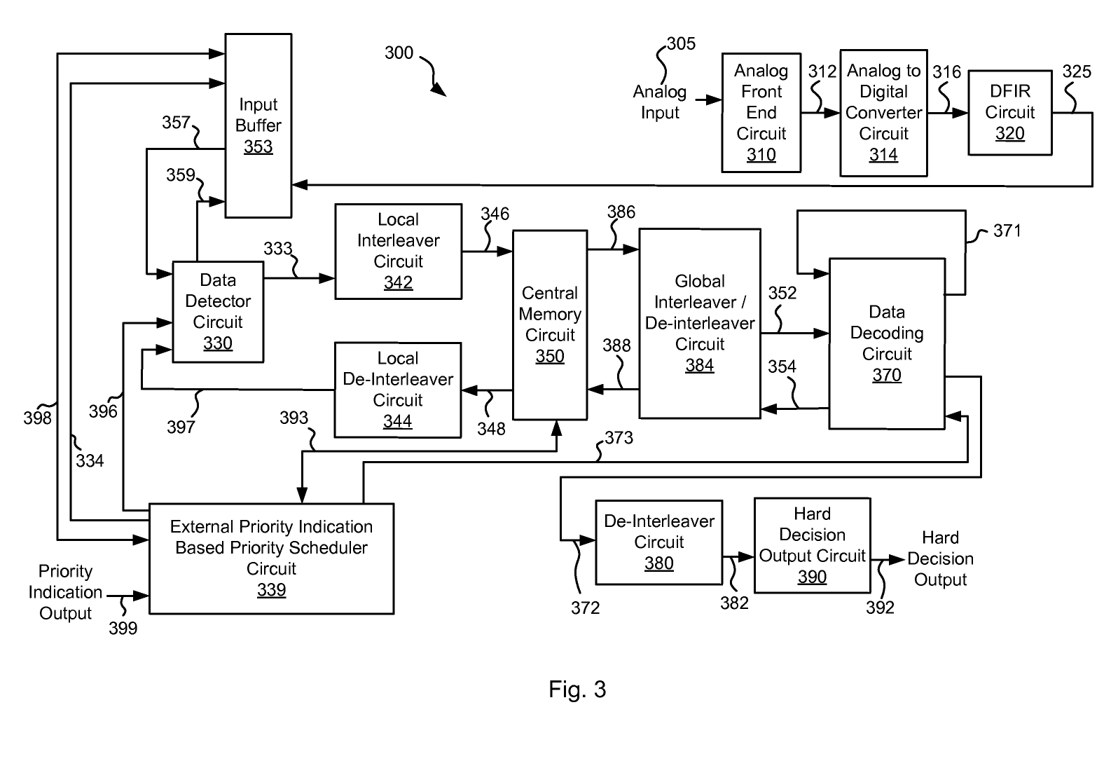

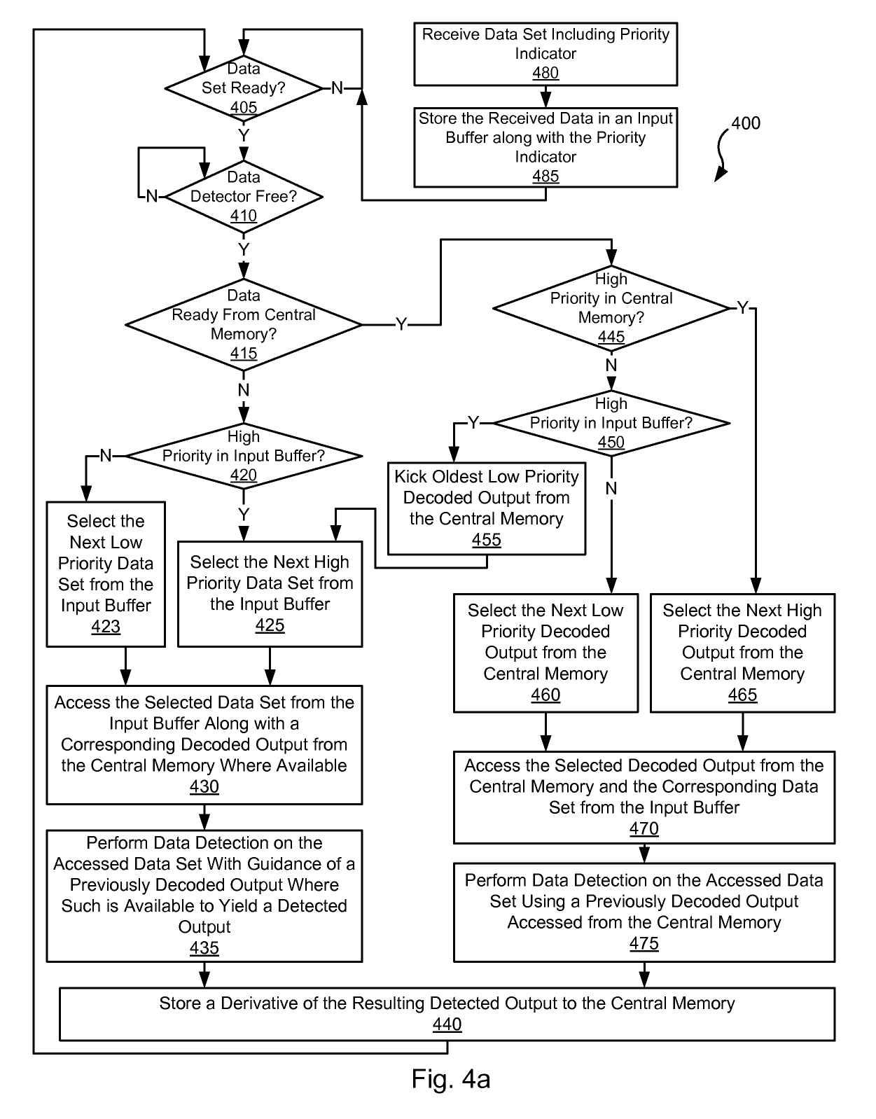

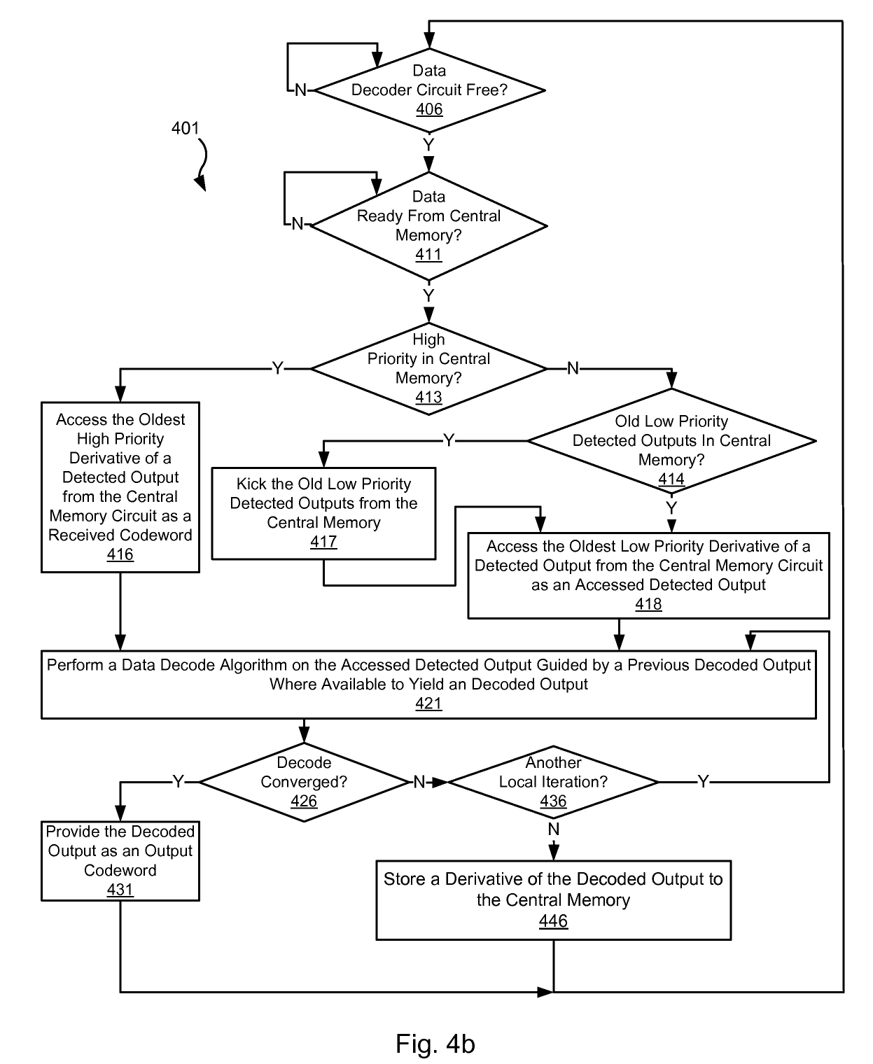

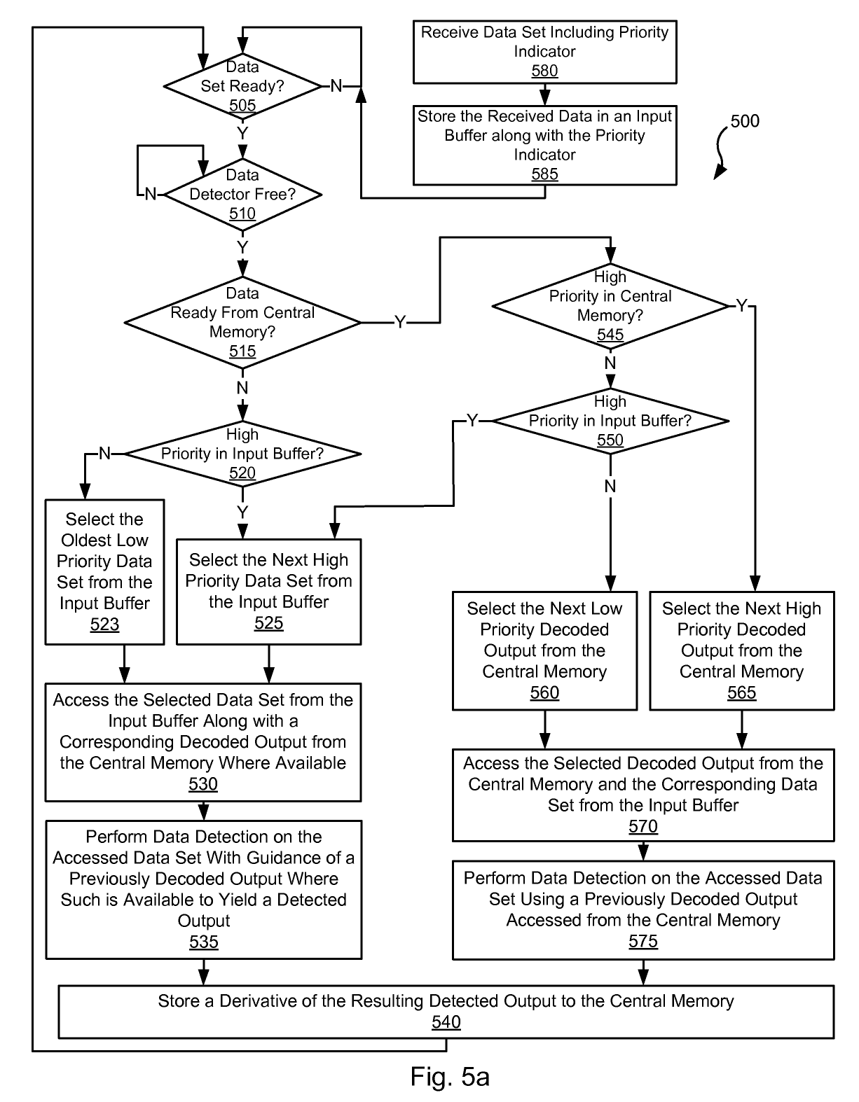

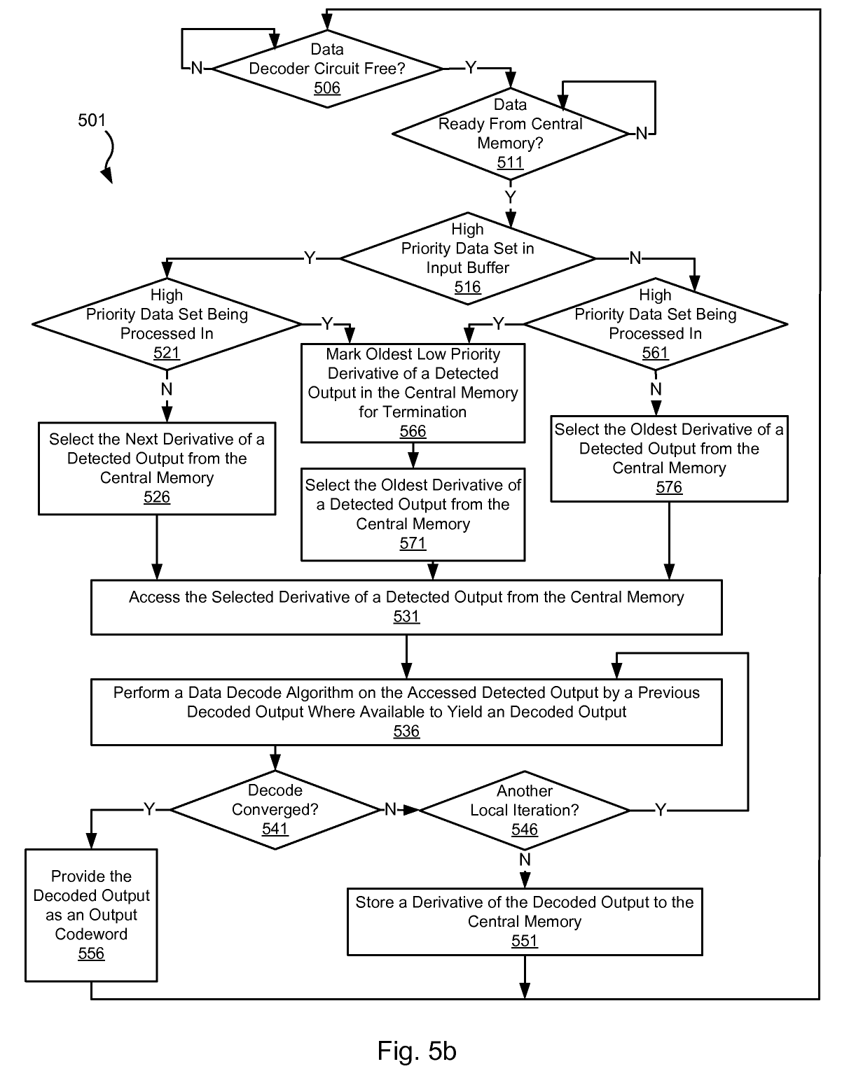

As part of processing the received information, read channel circuit 110 utilizes external priority indication based scheduling circuitry that operates to prioritize application of processing cycles to higher priority codewords (as used herein, the terms data set and codeword are used interchangeably to mean a set of data that is processed together) over lower priority codewords. Such an approach generally operates to reduce latency of higher priority codewords and increases latency of lower priority codewords while providing an increased number of processing cycles to high priority codewords at the expense of lower priority codewords. In some cases, read channel circuit 110 may be implemented to include a data processing circuit similar to that discussed below in relation to FIG. 3. Further, the prioritizing of codeword processing may be accomplished consistent with one of the approaches discussed below in relation to FIGS. 4a-4b, 5a-5b, and/or 6a-6b.

It should be noted that storage system 100 may be integrated into a larger storage system such as, for example, a RAID (redundant array of inexpensive disks or redundant array of independent disks) based storage system. Such a RAID storage system increases stability and reliability through redundancy, combining multiple disks as a logical unit. Data may be spread across a number of disks included in the RAID storage system according to a variety of algorithms and accessed by an operating system as if it were a single disk. For example, data may be mirrored to multiple disks in the RAID storage system, or may be sliced and distributed across multiple disks in a number of techniques. If a small number of disks in the RAID storage system fail or become unavailable, error correction techniques may be used to recreate the missing data based on the remaining portions of the data from the other disks in the RAID storage system. The disks in the RAID storage system may be, but are not limited to, individual storage systems such as storage system 100, and may be located in close proximity to each other or distributed more widely for increased security. In a write operation, write data is provided to a controller, which stores the write data across the disks, for example by mirroring or by striping the write data. In a read operation, the controller retrieves the data from the disks. The controller then yields the resulting read data as if the RAID storage system were a single disk.

A data decoder circuit used in relation to read channel circuit 110 may be, but is not limited to, a low density parity check (LDPC) decoder circuit as are known in the art. Such low density parity check technology is applicable to transmission of information over virtually any channel or storage of information on virtually any media. Transmission applications include, but are not limited to, optical fiber, radio frequency channels, wired or wireless local area networks, digital subscriber line technologies, wireless cellular, Ethernet over any medium such as copper or optical fiber, cable channels such as cable television, and Earth-satellite communications. Storage applications include, but are not limited to, hard disk drives, compact disks, digital video disks, magnetic tapes and memory devices such as DRAM, NAND flash, NOR flash, other non-volatile memories and solid state drives.

Turning to FIG. 2, a data transmission system 291 including a receiver 295 having external priority indication based priority scheduler circuitry is shown in accordance with various embodiments of the present invention. Data transmission system 291 includes a transmitter 293 that is operable to transmit encoded information via a transfer medium 297 as is known in the art. The encoded data is received from transfer medium 297 by a receiver 295.

Data transmission system 291 is accessed based upon instructions received from a host controller 290. Host controller 290 includes priority read indication circuitry operable to indicate that one or more transmitted data sets are of a higher priority that one or more other transmitted data sets. In a typical transmission operation, host controller 290 provides a data input that is to be transmitted by transmitter 293 to received 295. Along with the data input, host controller 290 provides a priority indication output that indicates one or more data sets within the data input are of a higher priority that one or more other data sets within the data input.

Receiver 295 processes the received input to yield the originally transmitted data. As part of processing the received information, receiver 295 utilizes priority information derived from the priority indication output to govern how to schedule processing of the information received via transfer medium 297. In particular, receiver 295 utilizes external priority indication based priority scheduling circuitry to prioritize application of processing cycles to higher priority codewords over lower priority codewords. Such an approach generally operates to reduce latency of higher priority codewords and increases latency of lower priority codewords while providing an increased number of processing cycles to high priority codewords at the expense of lower priority codewords. In some cases, receiver 295 may be implemented to include a data processing circuit similar to that discussed below in relation to FIG. 3. Further, the prioritizing of codeword processing may be accomplished consistent with one of the approaches discussed below in relation to FIGS. 4a-4b, 5a-5b, and/or 6a-6b.

FIG. 3 shows a data processing circuit 300 including an external priority indication based priority scheduler circuit 339 in accordance with some embodiments of the present invention. Data processing circuit 300 includes an analog front end circuit 310 that receives an analog signal 305. Analog front end circuit 310 processes analog signal 305 and provides a processed analog signal 312 to an analog to digital converter circuit 314. Analog front end circuit 310 may include, but is not limited to, an analog filter and an amplifier circuit as are known in the art. Based upon the disclosure provided herein, one of ordinary skill in the art will recognize a variety of circuitry that may be included as part of analog front end circuit 310. In some cases, analog signal 305 is derived from a read/write head assembly (not shown) that is disposed in relation to a storage medium (not shown). In other cases, analog signal 305 is derived from a receiver circuit (not shown) that is operable to receive a signal from a transmission medium (not shown). The transmission medium may be wired or wireless. Based upon the disclosure provided herein, one of ordinary skill in the art will recognize a variety of source from which analog input 305 may be derived.

Analog to digital converter circuit 314 converts processed analog signal 312 into a corresponding series of digital samples 316. Analog to digital converter circuit 314 may be any circuit known in the art that is capable of producing digital samples corresponding to an analog input signal. Based upon the disclosure provided herein, one of ordinary skill in the art will recognize a variety of analog to digital converter circuits that may be used in relation to different embodiments of the present invention. Digital samples 316 are provided to an equalizer circuit 320. Equalizer circuit 320 applies an equalization algorithm to digital samples 316 to yield an equalized output 325. In some embodiments of the present invention, equalizer circuit 320 is a digital finite impulse response filter circuit as are known in the art. It may be possible that equalized output 325 may be received directly from a storage device in, for example, a solid state storage system. In such cases, analog front end circuit 310, analog to digital converter circuit 314 and equalizer circuit 320 may be eliminated where the data is received as a digital data input. Equalized output 325 is stored to an input buffer 353 that includes sufficient memory to maintain one or more codewords until processing of that codeword is completed through a data detector circuit 330 and a data decoding circuit 370 including, where warranted, multiple global iterations (passes through both data detector circuit 330 and data decoding circuit 370) and/or local iterations (passes through data decoding circuit 370 during a given global iteration). An output 357 is provided to data detector circuit 330.

Data detector circuit 330 may be a single data detector circuit or may be two or more data detector circuits operating in parallel on different codewords. Whether it is a single data detector circuit or a number of data detector circuits operating in parallel, data detector circuit 330 is operable to apply a data detection algorithm to a received codeword or data set. In some embodiments of the present invention, data detector circuit 330 is a Viterbi algorithm data detector circuit as are known in the art. In other embodiments of the present invention, data detector circuit 330 is a maximum a posteriori data detector circuit as are known in the art. Of note, the general phrases “Viterbi data detection algorithm” or “Viterbi algorithm data detector circuit” are used in their broadest sense to mean any Viterbi detection algorithm or Viterbi algorithm detector circuit or variations thereof including, but not limited to, bi-direction Viterbi detection algorithm or bi-direction Viterbi algorithm detector circuit. Also, the general phrases “maximum a posteriori data detection algorithm” or “maximum a posteriori data detector circuit” are used in their broadest sense to mean any maximum a posteriori detection algorithm or detector circuit or variations thereof including, but not limited to, simplified maximum a posteriori data detection algorithm and a max-log maximum a posteriori data detection algorithm, or corresponding detector circuits. Based upon the disclosure provided herein, one of ordinary skill in the art will recognize a variety of data detector circuits that may be used in relation to different embodiments of the present invention. In some cases, one data detector circuit included in data detector circuit 330 is used to apply the data detection algorithm to the received codeword for a first global iteration applied to the received codeword, and another data detector circuit included in data detector circuit 330 is operable apply the data detection algorithm to the received codeword guided by a decoded output accessed from a central memory circuit 350 on subsequent global iterations.

Upon completion of application of the data detection algorithm to the received codeword on the first global iteration, data detector circuit 330 provides a detector output 333. Detector output 333 includes soft data. As used herein, the phrase “soft data” is used in its broadest sense to mean reliability data with each instance of the reliability data indicating a likelihood that a corresponding bit position or group of bit positions has been correctly detected. In some embodiments of the present invention, the soft data or reliability data is log likelihood ratio data as is known in the art. Detected output 333 is provided to a local interleaver circuit 342. Local interleaver circuit 342 is operable to shuffle sub-portions (i.e., local chunks) of the data set included as detected output and provides an interleaved codeword 346 that is stored to central memory circuit 350. Interleaver circuit 342 may be any circuit known in the art that is capable of shuffling data sets to yield a re-arranged data set. Interleaved codeword 346 is stored to central memory circuit 350.

Once data decoding circuit 370 is available, a previously stored interleaved codeword 346 is accessed from central memory circuit 350 as a stored codeword 386 and globally interleaved by a global interleaver/de-interleaver circuit 384. Global interleaver/De-interleaver circuit 384 may be any circuit known in the art that is capable of globally rearranging codewords. Global interleaver/De-interleaver circuit 384 provides a decoder input 352 into data decoding circuit 370. In some embodiments of the present invention, the data decode algorithm is a low density parity check algorithm as are known in the art. Based upon the disclosure provided herein, one of ordinary skill in the art will recognize other decode algorithms that may be used in relation to different embodiments of the present invention. Data decoding circuit 370 applies a data decode algorithm to decoder input 352 to yield a decoded output 371. In cases where another local iteration (i.e., another pass trough data decoder circuit 370) is desired, data decoding circuit 370 re-applies the data decode algorithm to decoder input 352 guided by decoded output 371. This continues until either a maximum number of local iterations is exceeded or decoded output 371 converges.

Where decoded output 371 fails to converge (i.e., fails to yield the originally written data set) and a number of local iterations through data decoder circuit 370 exceeds a threshold, the resulting decoded output is provided as a decoded output 354 back to central memory circuit 350 where it is stored awaiting another global iteration through a data detector circuit included in data detector circuit 330. Prior to storage of decoded output 354 to central memory circuit 350, decoded output 354 is globally de-interleaved to yield a globally de-interleaved output 388 that is stored to central memory circuit 350. The global de-interleaving reverses the global interleaving earlier applied to stored codeword 386 to yield decoder input 352. When a data detector circuit included in data detector circuit 330 becomes available, a previously stored de-interleaved output 388 accessed from central memory circuit 350 and locally de-interleaved by a de-interleaver circuit 344. De-interleaver circuit 344 re-arranges decoder output 348 to reverse the shuffling originally performed by interleaver circuit 342. A resulting de-interleaved output 397 is provided to data detector circuit 330 where it is used to guide subsequent detection of a corresponding data set previously received as equalized output 325.

Alternatively, where the decoded output converges (i.e., yields the originally written data set), the resulting decoded output is provided as an output codeword 372 to a de-interleaver circuit 380. De-interleaver circuit 380 rearranges the data to reverse both the global and local interleaving applied to the data to yield a de-interleaved output 382. De-interleaved output 382 is provided to a hard decision output circuit 390. Hard decision output circuit 390 is operable to re-order data sets that may complete out of order back into their original order. The originally ordered data sets are then provided as a hard decision output 392.

The order of processing data sets from input buffer 353 and those maintained in central memory circuit 350 is governed by external priority indication based priority scheduler circuit 339 based upon a priority indication output 399. Priority indication output 399 is derived from an input from a host controller (not shown), and indicates a priority level of data sets maintained in input buffer 353. When a data set is processed in through equalizer circuit 320, a priority indicator 334 is written to input buffer 353 in relation to the received data set or codeword. In one particular embodiment of the present invention, only two different priority levels are allowed—a high priority and a low priority. However, it should be noted that more than two different priority levels may be implemented in accordance with different embodiments of the present invention.

In addition, external priority indication based priority scheduler circuit 339 is operable to determine which data set in input buffer 353 is to be processed next by data detector circuit 330 and data decoder circuit 370. The next data set to be processed by data detector circuit 330 is selected by external priority indication based priority scheduler circuit 339 based upon priority levels and aging of data sets in input buffer 353 as reported to external priority indication based priority scheduler circuit 339 by an input status signal 398. In addition, the next data set to be processed by data decoder circuit 370 is selected by external priority indication based priority scheduler circuit 339 based upon priority levels and aging of data sets in input buffer 353 as reported to external priority indication based priority scheduler circuit 339 by input status signal 398 and aging of data sets maintained in central memory 350 as reported to external priority indication based priority scheduler circuit 339 by an memory status signal 393. The data set selected for processing by data detector circuit 330 is indicated to data detector circuit 330 by a selector signal 396 provided from external priority indication based priority scheduler circuit 339 to data detector circuit 330. The data set selected for processing by data decoder circuit 370 is indicated to data decoder circuit 370 by a selector signal 373 provided from external priority indication based priority scheduler circuit 339 to data decoder circuit 330.

In one particular embodiment of the present invention, input buffer 153 can hold a number (i.e., MAX DATA SETS) of data sets or codewords. In such a case, the largest number of low priority data sets (MAX LP DATA SETS) that may be maintained in input buffer 353 is defined by the following equation:

MAX LP DATA SETS=MAX DATA SETS−1.

Where external priority indication based priority scheduler circuit 339 determines that there is a high priority data set in input buffer 353, selector signal 396 is asserted by external priority indication based priority scheduler circuit 339 to cause data detector circuit 330 to select the oldest one of the high priority data sets for application of a data detection algorithm by data detector circuit 330. As used herein, the term “oldest” indicates the data set that has been stored in input buffer 353 for the longest time. Based upon the disclosure provided herein, one of ordinary skill in the art may recognize other selections that may be made in place of selecting the oldest. Otherwise, where no high priority data sets are available in input buffer 353, selector signal 396 is asserted by external priority indication based priority scheduler circuit 339 to cause data detector circuit 330 to select the oldest one of the low priority data sets for application of the data detection algorithm by data detector circuit 330. Again, based upon the disclosure provided herein, one of ordinary skill in the art may recognize other selections that may be made in place of selecting the oldest. Where external priority indication based priority scheduler circuit 339 determines that there is a high priority data set in input buffer 353 and central memory circuit 350 is full as indicated by memory status signal 393, then a selector signal 373 provided to data decoding circuit 370 causes data decoding circuit 370 to kick out the oldest low priority data set in central memory circuit 350 to make room for additional high priority data sets.

Where there are detected outputs in central memory circuit 350 corresponding to high priority data sets in input buffer 353, external priority indication based priority scheduler circuit 339 selects the oldest one of the detected outputs. Again, the term “oldest” indicates the detected output corresponding to the data set that has been stored in input buffer 353 for the longest time. Where hard decision output circuit 390 is overflowing or where a detected output in central memory corresponding to a low priority data set in input buffer 353 has exceeded a maximum number of global iterations, the oldest low priority data set in central memory circuit 350 is kicked out prior to a subsequent pass through data decoder circuit 370 to make room for additional high priority data sets. The aforementioned scheme does not guaranty a minimum number of global iterations for a low priority data set as it is possible for a low priority data set to be kicked out of data processing circuit 300 without application of the data detection algorithm or the data decode algorithm.

In another particular embodiment of the present invention, at least one global iteration through data detector circuit 330 and data decoder circuit 370 is guaranteed where only seven of eight openings in input buffer 353 may hold low priority data sets. In such a scheme, where external priority indication based priority scheduler circuit 339 determines that there is not a high priority data set in input buffer 353, selector signal 396 is asserted by external priority indication based priority scheduler circuit 339 to cause data detector circuit 330 to select the oldest one of the low priority data sets for application of a data detection algorithm by data detector circuit 330. Again, as used herein the term “oldest” indicates the data set that has been stored in input buffer 353 for the longest time. Based upon the disclosure provided herein, one of ordinary skill in the art may recognize other selections that may be made in place of selecting the oldest. Otherwise, where one or more high priority data sets are available in input buffer 353 but not in central memory circuit 350, selector signal 396 is asserted by external priority indication based priority scheduler circuit 339 to cause data detector circuit 330 to select the oldest one of the high priority data sets for application of the data detection algorithm by data detector circuit 330. Again, based upon the disclosure provided herein, one of ordinary skill in the art may recognize other selections that may be made in place of selecting the oldest.

Where there are not any high priority data sets in input buffer 353 and there are not any high priority data sets being processed through equalizer circuit 320 and written to input buffer 353, external priority indication based priority scheduler circuit 339 selects the oldest one of the detected outputs maintained in central memory circuit. Again, the term “oldest” indicates the detected output corresponding to the data set that has been stored in input buffer 353 for the longest time. Alternatively, where there are not any high priority data sets in input buffer 353, but there is a high priority data set being processed through equalizer circuit 320 and written to input buffer 353, external priority indication based priority scheduler circuit 339 selects the oldest one of the detected outputs maintained in central memory circuit 350 for processing by data decoder circuit 370 and the selected data set is kicked out of data processing circuit 300 regardless of convergence to make room for additional high priority data sets. As yet another alternative, where there is a high priority data set in input buffer 353 and there is a high priority data set being processed through equalizer circuit 320 and written to input buffer 353, external priority indication based priority scheduler circuit 339 selects the oldest one of the detected outputs maintained in central memory circuit 350 for processing by data decoder circuit 370 and the selected data set is kicked out of data processing circuit 300 regardless of convergence to make room for additional high priority data sets. As yet a further alternative, where there is a high priority data set in input buffer 353 and there is not a high priority data set being processed through equalizer circuit 320 and written to input buffer 353, external priority indication based priority scheduler circuit 339 selects the oldest one of the detected outputs maintained in central memory circuit 350 for processing by data decoder circuit 370. In such a condition, data sets are kicked out of data processing circuit 300 based upon a standard completion algorithm.

In yet another particular embodiment of the present invention, at least one global iteration through data detector circuit 330 and data decoder circuit 370 is guaranteed and two global iterations are guaranteed for three out of four low priority data sets maintained in input buffer 353. In such a case, only four of eight openings in input buffer 353 may hold low priority data sets. In such a scheme, where external priority indication based priority scheduler circuit 339 determines that there is not a high priority data set in input buffer 353, selector signal 396 is asserted by external priority indication based priority scheduler circuit 339 to cause data detector circuit 330 to select the oldest one of the low priority data sets that has already been processed on or less global iterations through data detector circuit 330 and data decoder circuit 370. Again, as used herein the term “oldest” indicates the data set that has been stored in input buffer 353 for the longest time. Based upon the disclosure provided herein, one of ordinary skill in the art may recognize other selections that may be made in place of selecting the oldest. Otherwise, where one or more high priority data sets are available in input buffer 353 but not in central memory circuit 350, selector signal 396 is asserted by external priority indication based priority scheduler circuit 339 to cause data detector circuit 330 to select the oldest one of the high priority data sets for application of the data detection algorithm by data detector circuit 330. Again, based upon the disclosure provided herein, one of ordinary skill in the art may recognize other selections that may be made in place of selecting the oldest.

Where there are not any high priority data sets in input buffer 353 and there are not any high priority data sets being processed through equalizer circuit 320 and written to input buffer 353, external priority indication based priority scheduler circuit 339 selects the oldest one of the detected outputs maintained in central memory circuit 350 for application of the data decode algorithm by data decoder circuit 370. Again, the term oldest indicates the detected output corresponding to the data set that has been stored in input buffer 353 for the longest time. Alternatively, where there are not any high priority data sets in input buffer 353, but there is a high priority data set being processed through equalizer circuit 320 and written to input buffer 353, external priority indication based priority scheduler circuit 339 selects the oldest one of the detected outputs maintained in central memory circuit 350 for processing by data decoder circuit 370 and the oldest low priority data set is kicked out of data processing circuit 300 regardless of convergence after one global iteration to make room for additional high priority data sets. In addition, the next two oldest low priority data sets are marked to be kicked out of data processing circuit 330 upon completion of a second global iteration for each of the respective data sets. As yet another alternative, where there is a high priority data set in input buffer 353 and there is a high priority data set being processed through equalizer circuit 320 and written to input buffer 353, external priority indication based priority scheduler circuit 339 selects the oldest one of the detected outputs maintained in central memory circuit 350 for processing by data decoder circuit 370 and the oldest low priority data set is marked to be kicked out of data processing circuit 300 upon completion of a second global iteration regardless of convergence to make room for additional high priority data sets. As yet a further alternative, there is a high priority data set in input buffer 353 and there is a high priority data set being processed through equalizer circuit 320 and written to input buffer 353, external priority indication based priority scheduler circuit 339 selects the oldest one of the detected outputs maintained in central memory circuit 350 for processing by data decoder circuit 370. In such a condition, data sets are kicked out of data processing circuit 300 based upon a standard completion algorithm.

FIG. 4a is a flow diagram 400 showing a method for external priority indication based priority data processing in accordance with some embodiments of the present invention. Following flow diagram 400, a data set is received along with a corresponding priority indicator (block 480). This data set may be received, for example, from a storage medium or a communication medium. As the data set is received, it is stored in an input buffer along with the priority indicator (block 485). It is repeatedly determined whether a data set is ready for processing (block 405). A data set may become ready for processing where either the data set was previously processed and a data decode has completed in relation to the data set and the respective decoded output is available in a central memory, or where a previously unprocessed data set becomes available in the input buffer. Where a data set is ready (block 405), it is determined whether a data detector circuit is available to process the data set (block 410). The data detector circuit may be, for example, a Viterbi algorithm data detector circuit or a maximum a posteriori data detector circuit as are known in the art

Where the data detector circuit is available for processing (block 410), it is determined whether there is a decoded output in the central memory that is ready for additional processing (block 415). Where there is not a decoded output in the central memory (block 415), it is determined whether there is a high priority data set in the input buffer for processing (block 420). Where there is not a high priority data set in the input buffer awaiting processing (block 420), then the next low priority data set in the input buffer is selected for processing by the data detector circuit (block 423). The “next” low priority data set may be selected based upon any scheduling algorithm known in the art. Alternatively, where there is a high priority data set in the input buffer awaiting processing (block 420), then the next high priority data set in the input buffer is selected for processing by the data detector circuit (block 425). The “next” high priority data set may be selected based upon any scheduling algorithm known in the art. The selected data set is accessed from the input buffer (block 430). Where this is the second or later global iteration for the selected data set, a corresponding decoded output is also accessed from the central memory. A data detection algorithm is then applied to the accessed data set to yield a detected output (block 435). Where it is a second or later global iteration for the accessed data set, the corresponding decoded output is used to guide application of the data detection algorithm. The data detection algorithm may be, but is not limited to, a maximum a posteriori data detection algorithm or a Viterbi data detection algorithm. Based upon the disclosure provided herein, one of ordinary skill in the art will recognize a variety of data detection algorithms that may be used in relation to different embodiments of the present invention. A derivative of the detected output is stored to the central memory (block 440). The derivative of the detected output may be, for example, an interleaved or shuffled version of the detected output.

Alternatively, where a decoded output is available in the central memory and ready for additional processing (bock 415), it is determined whether there is a high priority data set in the central memory for processing (block 445). Where there is not a high priority data set in the input buffer awaiting processing (block 445), it is determined whether there is a high priority data set in the input buffer for processing (block 450). Where there is a high priority data set in the input buffer awaiting processing (block 450), the data set in the central memory corresponding to a low priority data set in the input buffer is kicked out of the system regardless of convergence if the central memory is full (block 455). In addition, the processes of blocks 425, 430, 435, 440 are repeated for the high priority data set in the input buffer.

Alternatively, where there is not a high priority data set in the input buffer (block 450), the next low priority decoded output from the central memory is selected (block 460). The “next” low priority data set may be selected based upon any scheduling algorithm known in the art. As yet another alternative, where there is a high priority data set in the central memory for processing (block 445), the next high priority decoded output from the central memory is selected (block 465). The “next” high priority data set may be selected based upon any scheduling algorithm known in the art. The selected decoded output is accessed from the central memory along with the corresponding data set from the input buffer (block 470). The data detection algorithm is then applied to the accessed data set guided by the decoded output to yield a detected output (block 475). A derivative of the detected output is stored to the central memory (block 440).

Turning to FIG. 4b, a flow diagram 401 shows a counterpart of the method described above in relation to FIG. 4a. Following flow diagram 401, in parallel to the previously described data detection process of FIG. 4a, it is determined whether a data decoder circuit is available (block 406). The data decoder circuit may be, for example, a low density data decoder circuit as are known in the art. Where the data decoder circuit is available (block 406), it is determined whether a derivative of a detected output is available for processing in the central memory (block 411). Where such a data set is ready (block 411), it is determined whether a high priority data set is available in the central memory (block 413). Where a high priority data set is not available in the central memory (block 413), it is determined whether any of the low priority data sets available in the central memory are too old (block 414). Too old may be defined, for example, as having exceeded their maximum latency in the processing system or that an output buffer is full (block 414). Where such is the case (block 414), all low priority data sets that are identified as too old are kicked out of the system regardless of convergence (block 417). In any event, the oldest low priority data set (i.e., derivative of a detected output) is accessed from the central memory as an accessed detected output (block 418). Alternatively, where there is a high priority data set available in the central memory (block 413), the oldest high priority data set (i.e., derivative of a detected output) is accessed from the central memory as the accessed detected output (block 416).

A data decode algorithm is applied to the accessed detected output to yield a decoded output (block 421). Where a previous local iteration has been performed on the received codeword, the results of the previous local iteration (i.e., a previous decoded output) are used to guide application of the decode algorithm. It is then determined whether the decoded output converged (i.e., resulted in the originally written data) (block 426). Where the decoded output converged (block 426), it is provided as an output codeword (block 431). Alternatively, where the decoded output failed to converge (block 426), it is determined whether another local iteration is desired (block 436). In some cases, four local iterations are allowed per each global iteration. Based upon the disclosure provided herein, one of ordinary skill in the art will recognize another number of local iterations that may be used in relation to different embodiments of the present invention. Where another local iteration is desired (block 436), the processes of blocks 421-436 are repeated for the accessed detected output. Alternatively, where another local iteration is not desired (block 436), a derivative of the decoded output is stored to the central memory (block 446). The derivative of the decoded output being stored to the central memory triggers the data set ready query of block 405 to begin the data detection process.

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

FIG. 5a is a flow diagram 500 showing another method for external priority indication based priority data processing in accordance with other embodiments of the present invention. Following flow diagram 500, a data set is received along with a corresponding priority indicator (block 580). This data set may be received, for example, from a storage medium or a communication medium. As the data set is received, it is stored in an input buffer along with the priority indicator (block 585). It is repeatedly determined whether a data set is ready for processing (block 505). A data set may become ready for processing where either the data set was previously processed and a data decode has completed in relation to the data set and the respective decoded output is available in a central memory, or where a previously unprocessed data set becomes available in the input buffer. Where a data set is ready (block 505), it is determined whether a data detector circuit is available to process the data set (block 510). The data detector circuit may be, for example, a Viterbi algorithm data detector circuit or a maximum a posteriori data detector circuit as are known in the art

Where the data detector circuit is available for processing (block 510), it is determined whether there is a decoded output in the central memory that is ready for additional processing (block 515). Where there is not a decoded output in the central memory (block 515), it is determined whether there is a high priority data set in the input buffer for processing (block 520). Where there is not a high priority data set in the input buffer awaiting processing (block 520), then the oldest low priority data set in the input buffer is selected for processing by the data detector circuit (block 523). The term “oldest” indicates the data set that has been stored in the input buffer for the longest time. Alternatively, where there is a high priority data set in the input buffer awaiting processing (block 520), then the next high priority data set in the input buffer is selected for processing by the data detector circuit (block 525). The “next” high priority data set may be selected based upon any scheduling algorithm known in the art. The selected data set is accessed from the input buffer (block 530). Where this is the second or later global iteration for the selected data set, a corresponding decoded output is also accessed from the central memory. A data detection algorithm is then applied to the accessed data set to yield a detected output (block 535). Where it is a second or later global iteration for the accessed data set, the corresponding decoded output is used to guide application of the data detection algorithm. The data detection algorithm may be, but is not limited to, a maximum a posteriori data detection algorithm or a Viterbi data detection algorithm. Based upon the disclosure provided herein, one of ordinary skill in the art will recognize a variety of data detection algorithms that may be used in relation to different embodiments of the present invention. A derivative of the detected output is stored to the central memory (block 540). The derivative of the detected output may be, for example, an interleaved or shuffled version of the detected output.

Alternatively, where a decoded output is available in the central memory and ready for additional processing (bock 515), it is determined whether there is a high priority data set in the central memory for processing (block 545). Where there is not a high priority data set in the input buffer awaiting processing (block 545), it is determined whether there is a high priority data set in the input buffer for processing (block 550). Where there is a high priority data set in the input buffer awaiting processing (block 550), blocks 525, 530, 535, 540 are repeated for the high priority data set in the input buffer.

Alternatively, where there is not a high priority data set in the input buffer (block 550), the next low priority decoded output from the central memory is selected (block 560). The “next” low priority data set may be selected based upon any scheduling algorithm known in the art. As yet another alternative, where there is a high priority data set in the central memory for processing (block 545), the next high priority decoded output from the central memory is selected (block 565). The “next” high priority data set may be selected based upon any scheduling algorithm known in the art. The selected decoded output is accessed from the central memory along with the corresponding data set from the input buffer (block 570). The data detection algorithm is then applied to the accessed data set guided by the decoded output to yield a detected output (block 575). A derivative of the detected output is stored to the central memory (block 540).

Turning to FIG. 5b, a flow diagram 501 shows a counterpart of the method described above in relation to FIG. 5a. Following flow diagram 501, in parallel to the previously described data detection process of FIG. 5a, it is determined whether a data decoder circuit is available (block 506). The data decoder circuit may be, for example, a low density data decoder circuit as are known in the art. Where the data decoder circuit is available (block 506), it is determined whether a derivative of a detected output is available for processing in the central memory (block 511). Where such a data set is ready (block 511), it is determined whether a high priority data set is available in the input buffer (block 516). Where a high priority data set is not available in the input buffer (block 516), it is determined whether a high priority data set is currently being processed through an equalizer circuit and written to the input buffer (block 561). Where a high priority data set is not currently being processed through an equalizer circuit and written to the input buffer (block 561), the oldest derivative of a detected output decoded output is selected from the central memory (block 576). Alternatively, where a high priority data set is currently being processed through an equalizer circuit and written to the input buffer (block 561), the oldest low priority derivative of a detected output is marked to be kicked out of the processing system after completion of the subsequent application of the data decode algorithm regardless of convergence (block 566). The oldest low priority derivative of a detected output is selected from the central memory (block 571).

Alternatively, where a high priority data set is available in the input buffer (block 516), it is determined whether a high priority data set is currently being processed through an equalizer circuit and written to the input buffer (block 521). Where a high priority data set is currently being processed through an equalizer circuit and written to the input buffer (block 521), the oldest low priority derivative of a detected output is marked to be kicked out of the processing system after completion of the subsequent application of the data decode algorithm regardless of convergence (block 566). The oldest low priority derivative of a detected output is selected from the central memory (block 571). Alternatively, where a high priority data set is not currently being processed through an equalizer circuit and written to the input buffer (block 521), the next derivative of a detected output is selected from the central memory (block 526). The “next” derivative of a detected output may be selected based upon any scheduling algorithm known in the art

The selected derivative of a detected output is accessed from the central memory (block 531). A data decode algorithm is applied to the accessed derivative of a detected output to yield a decoded output (block 536). Where a previous local iteration has been performed on the accessed derivative of a detected output, the results of the previous local iteration (i.e., a previous decoded output) are used to guide application of the decode algorithm. It is then determined whether the decoded output converged (i.e., resulted in the originally written data) (block 541). Where the decoded output converged (block 541), it is provided as an output codeword (block 556). Alternatively, where the decoded output failed to converge (block 541), it is determined whether another local iteration is desired (block 546). In some cases, four local iterations are allowed per each global iteration. Based upon the disclosure provided herein, one of ordinary skill in the art will recognize another number of local iterations that may be used in relation to different embodiments of the present invention. Where another local iteration is desired (block 546), the processes of blocks 536-541 are repeated for the accessed detected output. Alternatively, where another local iteration is not desired (block 546), a derivative of the decoded output is stored to the central memory (block 551). The derivative of the decoded output being stored to the central memory triggers the data set ready query of block 505 to begin the data detection process.

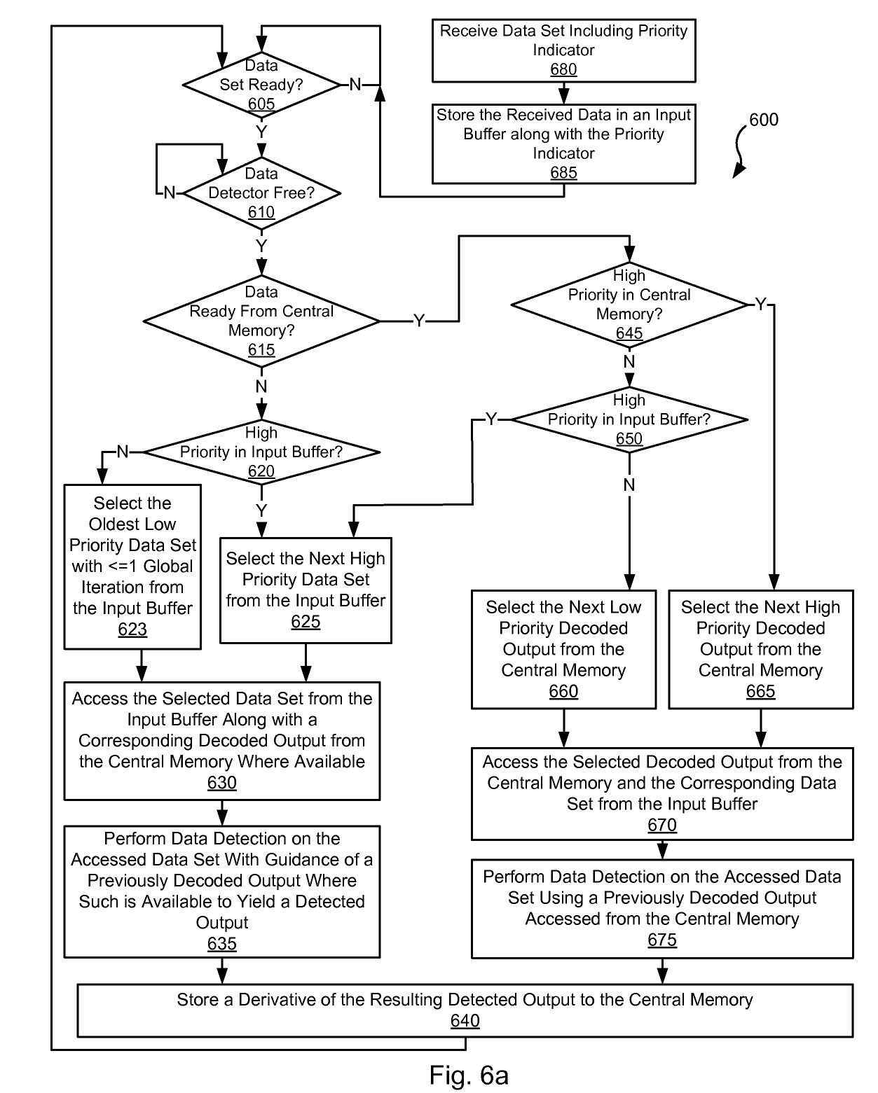

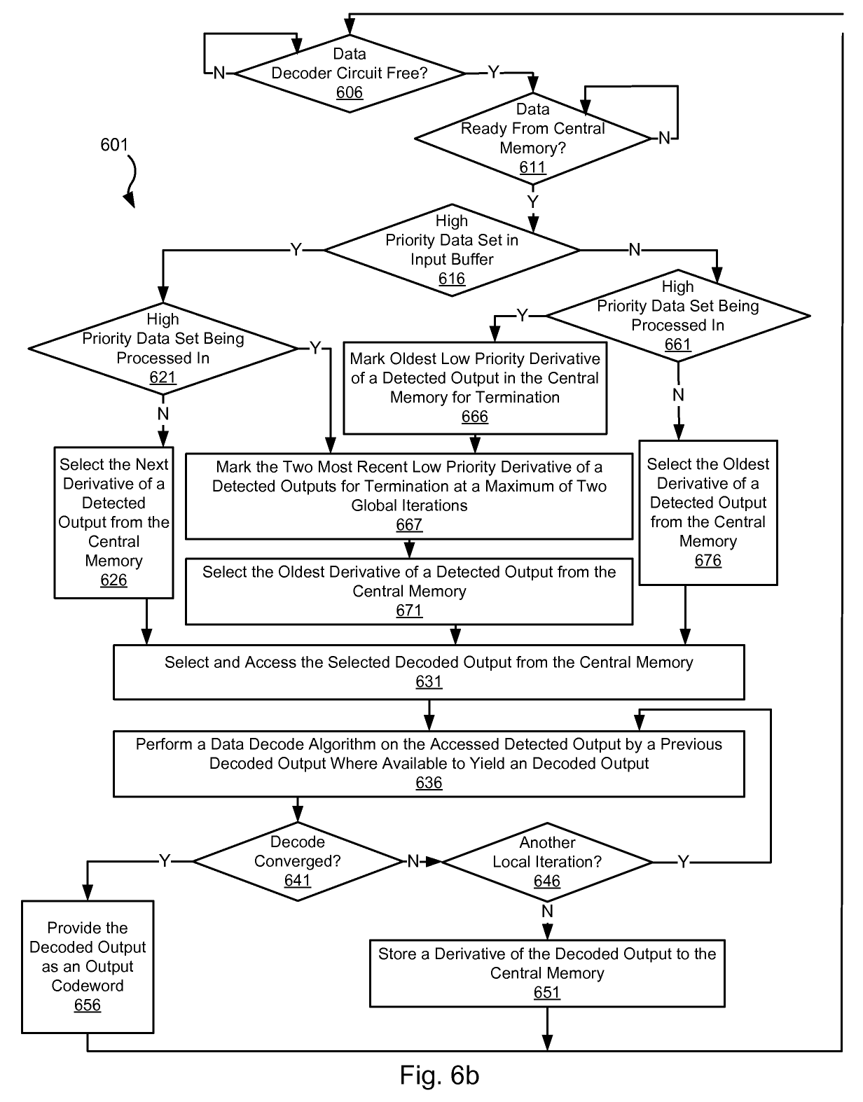

FIG. 6a is a flow diagram 600 showing yet another method for external priority indication based priority data processing in accordance with yet other embodiments of the present invention. Following flow diagram 600, a data set is received along with a corresponding priority indicator (block 680). This data set may be received, for example, from a storage medium or a communication medium. As the data set is received, it is stored in an input buffer along with the priority indicator (block 685). It is repeatedly determined whether a data set is ready for processing (block 605). A data set may become ready for processing where either the data set was previously processed and a data decode has completed in relation to the data set and the respective decoded output is available in a central memory, or where a previously unprocessed data set becomes available in the input buffer. Where a data set is ready (block 605), it is determined whether a data detector circuit is available to process the data set (block 610). The data detector circuit may be, for example, a Viterbi algorithm data detector circuit or a maximum a posteriori data detector circuit as are known in the art

Where the data detector circuit is available for processing (block 610), it is determined whether there is a decoded output in the central memory that is ready for additional processing (block 615). Where there is not a decoded output in the central memory (block 615), it is determined whether there is a high priority data set in the input buffer for processing (block 620). Where there is not a high priority data set in the input buffer awaiting processing (block 620), then the oldest low priority data set in the input buffer that has been processed one or less global iterations through a data detector and data decoder circuit is selected for processing by the data detector circuit (block 623). The term “oldest” indicates the data set that has been stored in the input buffer for the longest time. Alternatively, where there is a high priority data set in the input buffer awaiting processing (block 620), then the next high priority data set in the input buffer is selected for processing by the data detector circuit (block 625). The “next” high priority data set may be selected based upon any scheduling algorithm known in the art. The selected data set is accessed from the input buffer (block 630). Where this is the second or later global iteration for the selected data set, a corresponding decoded output is also accessed from the central memory. A data detection algorithm is then applied to the accessed data set to yield a detected output (block 635). Where it is a second or later global iteration for the accessed data set, the corresponding decoded output is used to guide application of the data detection algorithm. The data detection algorithm may be, but is not limited to, a maximum a posteriori data detection algorithm or a Viterbi data detection algorithm. Based upon the disclosure provided herein, one of ordinary skill in the art will recognize a variety of data detection algorithms that may be used in relation to different embodiments of the present invention. A derivative of the detected output is stored to the central memory (block 640). The derivative of the detected output may be, for example, an interleaved or shuffled version of the detected output.

Alternatively, where a decoded output is available in the central memory and ready for additional processing (bock 615), it is determined whether there is a high priority data set in the central memory for processing (block 645). Where there is not a high priority data set in the input buffer awaiting processing (block 645), it is determined whether there is a high priority data set in the input buffer for processing (block 650). Where there is a high priority data set in the input buffer awaiting processing (block 650), blocks 625, 630, 635, 640 are repeated for the high priority data set in the input buffer.

Alternatively, where there is not a high priority data set in the input buffer (block 650), the next low priority decoded output from the central memory is selected (block 660). The “next” low priority data set may be selected based upon any scheduling algorithm known in the art. As yet another alternative, where there is a high priority data set in the central memory for processing (block 645), the next high priority decoded output from the central memory is selected (block 665). The “next” high priority data set may be selected based upon any scheduling algorithm known in the art. The selected decoded output is accessed from the central memory along with the corresponding data set from the input buffer (block 670). The data detection algorithm is then applied to the accessed data set guided by the decoded output to yield a detected output (block 675). A derivative of the detected output is stored to the central memory (block 640).

Turning to FIG. 6b, a flow diagram 601 shows a counterpart of the method described above in relation to FIG. 5a. Following flow diagram 601, in parallel to the previously described data detection process of FIG. 6a, it is determined whether a data decoder circuit is available (block 606). The data decoder circuit may be, for example, a low density data decoder circuit as are known in the art. Where the data decoder circuit is available (block 606), it is determined whether a derivative of a detected output is available for processing in the central memory (block 611). Where such a data set is ready (block 611), it is determined whether a high priority data set is available in the input buffer (block 616). Where a high priority data set is not available in the input buffer (block 616), it is determined whether a high priority data set is currently being processed through an equalizer circuit and written to the input buffer (block 661). Where a high priority data set is not currently being processed through an equalizer circuit and written to the input buffer (block 661), the oldest derivative of a detected output decoded output is selected from the central memory (block 676). Alternatively, where a high priority data set is currently being processed through an equalizer circuit and written to the input buffer (block 661), the oldest low priority derivative of a detected output is marked to be kicked out of the processing system after completion of the subsequent application of the data decode algorithm regardless of convergence (block 666). In addition, the two most recent low priority derivative of the detected outputs are marked for termination upon completion of a maximum of two global iterations (block 667). The oldest low priority derivative of a detected output is selected from the central memory (block 671).

Alternatively, where a high priority data set is available in the input buffer (block 616), it is determined whether a high priority data set is currently being processed through an equalizer circuit and written to the input buffer (block 621). Where a high priority data set is currently being processed through an equalizer circuit and written to the input buffer (block 621), the two most recent low priority derivative of the detected outputs are marked for termination upon completion of a maximum of two global iterations (block 667). The oldest low priority derivative of a detected output is selected from the central memory (block 671). Alternatively, where a high priority data set is not currently being processed through an equalizer circuit and written to the input buffer (block 621), the next derivative of a detected output is selected from the central memory (block 626). The “next” derivative of a detected output may be selected based upon any scheduling algorithm known in the art

The selected derivative of a detected output is accessed from the central memory (block 631). A data decode algorithm is applied to the accessed derivative of a detected output to yield a decoded output (block 636). Where a previous local iteration has been performed on the accessed derivative of a detected output, the results of the previous local iteration (i.e., a previous decoded output) are used to guide application of the decode algorithm. It is then determined whether the decoded output converged (i.e., resulted in the originally written data) (block 641). Where the decoded output converged (block 641), it is provided as an output codeword (block 656). Alternatively, where the decoded output failed to converge (block 641), it is determined whether another local iteration is desired (block 646). In some cases, four local iterations are allowed per each global iteration. Based upon the disclosure provided herein, one of ordinary skill in the art will recognize another number of local iterations that may be used in relation to different embodiments of the present invention. Where another local iteration is desired (block 646), the processes of blocks 636-641 are repeated for the accessed detected output. Alternatively, where another local iteration is not desired (block 646), a derivative of the decoded output is stored to the central memory (block 651). The derivative of the decoded output being stored to the central memory triggers the data set ready query of block 605 to begin the data detection process.

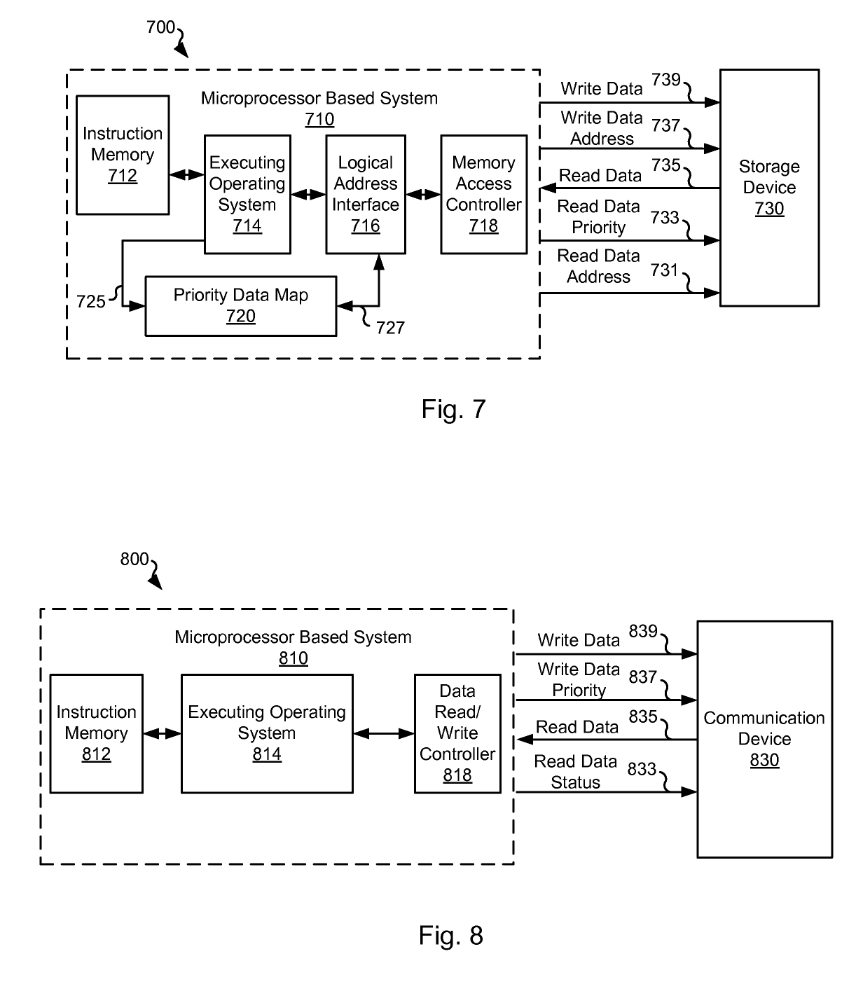

Turning to FIG. 7, an application device 700 including a microprocessor based system 710 operable to access a storage device 730 using priority based access commands is shown in accordance with some embodiments of the present invention. Application device 700 may be, for example, a personal computer, a personal digital assistant, an electronic application device, or any of a number of other devices known in the art that access information from a storage device. Microprocessor based system 710 includes a microprocessor that includes operating system execution modules generically referred to as an executing operating system 714 that accesses instructions to be executed from an instruction memory 712 that is loaded with data accessed from storage device 730 or another storage media (not shown). As executing operating system 714 identifies data that is required for operating, it formats a data request that includes a logical address of the requested data.

The data request is provided from executing operating system 714 to a logical address interface 716 that maps the logical address of the data request to a physical address that is provided to a memory access controller 718. In addition, logical address interface 716 also accesses a priority data map 720 to determine whether the requested data is high priority data or low priority data via a communication path 727. It should be noted that while the priority data map is described as indicating high priority data or low priority data, that additional levels of priority may also be used in relation to different embodiments of the present invention. Executing operating system 714 is responsible for identifying different logical blocks as high priority or low priority s data is originally stored to storage device 730. For example, data which can accept some level of errors may be identified as low priority data causing it to receive fewer iterations through a data processing circuit included as part of storage device 730. In some cases, storage device 730 includes a data processing circuit similar to that discussed above in relation to FIG. 3. Again, the data processing circuit described above in relation to FIG. 3 may operate similar to that described above in relation to FIGS. 4-6 above. Examples of low priority data may include, but is not limited to, audio data or video data that when it includes errors is still playable and meaningful. In contrast, executables maintained on storage device 730 may be marked as high priority as they must be received without errors to assure that they operate properly. Based upon the disclosure provided herein, one of ordinary skill in the art will recognize a variety of different data types that may be identified as low priority and other data types that may be identified as high priority in accordance with different embodiments of the present invention. Logical address interface 716 provides the identified priority level along with the physical address to memory access controller 718.

As another example that does not use priority data map 720, a data request from executing operating system 714 may indicate certain relatively small sub-blocks of data being requested from storage device 730. In turn, logical address interface 716 generates physical addresses corresponding to the logical addresses of the sub-blocks of data requested by executed operating system. In the process, logical address interface 716 requests a large contiguous block of data incorporating one or more sub-blocks. Along with the request for the contiguous block of data to memory access controller 718, logical address interface 716 identifies the sub-blocks requested by executed operating system 714 (i.e., data sets that are primary to the data request) as high priority and the other sub-blocks within the contiguous block as low priority (i.e., data sets that are secondary to the data request). Such an approach results in more processing iterations being applied by a processing circuit of storage device 730 to the high priority data at the expense of the low priority data where the processing circuit is implemented similar to that discussed above in relation to FIG. 3. Again, the data processing circuit described above in relation to FIG. 3 may operate similar to that described above in relation to FIGS. 4-6 above.

Memory access controller 718 converts the request including priority indications as a read data priority 733 and read data address 731 to storage device 730. In return, storage device 730 provides the request data as read data 735 to microprocessor based system 710 where it is used. As an example, read data 735 may include instructions executable a part of the operating system in which case microprocessor based system 710 stores the data to instruction memory 712 where it is maintained until it is needed.

Writing data from microprocessor based system 710 uses a standard approach of providing a logical write address from executing operating system 714 to logical address interface 716 where the logical address is converted to a physical address that is provided to memory access controller 718 along with the data to be written. In such a case, memory access controller 718 provides a write data address 737 and a write data 739 to storage device 730 that in turn stores the received data. As part of this process, executing operating system 714 identifies the written data as high priority or low priority to priority data map 720 when data type based priority identification is used. This priority information may be used later when a request to read the written data is generated.

Turning to FIG. 8, another application device 800 including a microprocessor based system 810 operable to transfer information to a communication device 830 using priority based access commands is shown in accordance with various embodiments of the present invention. application device 800 may be, for example, a cell phone, a network device, a personal computer, a personal digital assistant, or any of a number of other devices known in the art that access information from a storage device. Microprocessor based system 810 includes a microprocessor having operating system execution modules generically referred to as an executing operating system 814 that accesses instructions to be executed from an instruction memory 812 that is loaded with data accessed from a storage device (not shown). As executing operating system 814 receives commands to transfer data via communication device 830, it prepares the data for transfer and writes the data to a data read/write controller 818. In addition, executing operating system 814 indicates a level of priority associated with the data being transferred to data read/write controller 818. In turn, data read/write controller 818 provides a write data 839 and a corresponding write data priority 837 to communication device 830.

Write data 839 and write data priority 837 are communicated to a receiving device (not shown) that processes the communicated write data and corresponding write data priority to yield the originally written data to a recipient (not shown). In some cases, the receiving device includes a data processing circuit similar to that discussed above in relation to FIG. 3. Again, the data processing circuit described above in relation to FIG. 3 may operate similar to that described above in relation to FIGS. 4-6 above. Examples of low priority data may include, but is not limited to, audio data or video data that when it includes errors is still playable and meaningful. In contrast, executable data or other more sensitive data may be identified as high priority data. Based upon the disclosure provided herein, one of ordinary skill in the art will recognize a variety of different data types that may be identified as low priority and other data types that may be identified as high priority in accordance with different embodiments of the present invention.

Receiving read data from communication device 830 is standard where read data 835 is received from communication device 830 and provided to the appropriate applications operating on microprocessor based system 810. A read data status 833 provides status of the read process to communication device 830. In some cases, communication device 830 receives communicated data that is processed and provided as read data 835 in accordance with a priority indication communicated along with the communicated data. In such cases, communication device 830 may include a data processing circuit similar to that discussed above in relation to FIG. 3. Again, the data processing circuit described above in relation to FIG. 3 may operate similar to that described above in relation to FIGS. 4-6 above.

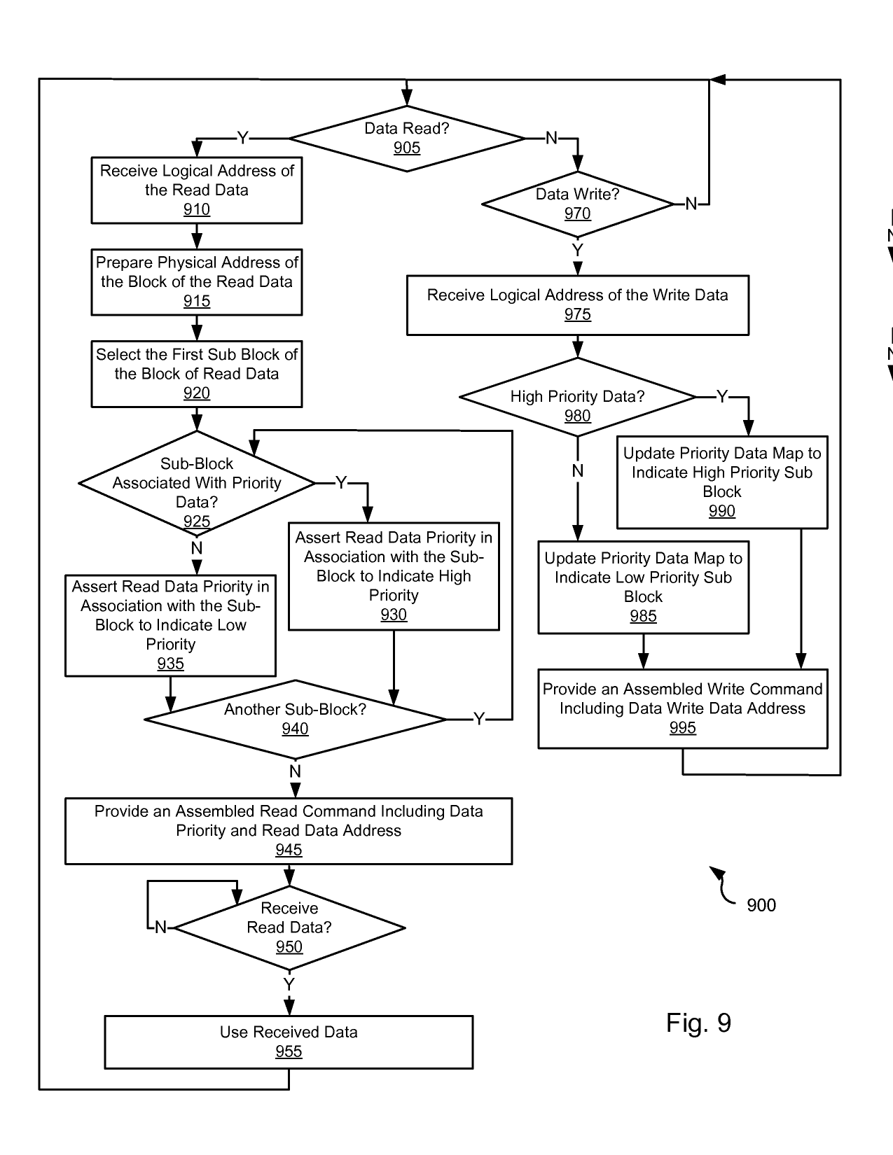

Turning to FIG. 9, a flow diagram 900 shows a method for priority based access to a storage device in accordance with one or more embodiments of the present invention. Following flow diagram 900, it is determined whether data is to be read from a storage device (block 905). Where data is not to be read from the storage device (block 905), it is determined whether data is to be written to the storage device (block 970). Where data is to be written to the storage device (block 970), a logical address of the data to be written is received (block 975). In addition, it is determined whether the data to be written is high priority data or low priority data (block 980). Where the data to be written is high priority data (block 970), a priority data map is updated to indicate a high priority sub-block corresponding to the logical address of the write (block 990). Alternatively, where the data to be written is low priority data (block 970), the priority data map is updated to indicate a low priority sub-block corresponding to the logical address of the write (block 985). It should be noted that while the priority data map is described as indicating high priority data or low priority data, that additional levels of priority may also be used in relation to different embodiments of the present invention.

In some cases, data which can accept some level of errors may be identified as low priority data causing it to receive fewer iterations through a data processing circuit included as part of storage the storage device to which it is written. In some cases, such a storage device includes a data processing circuit similar to that discussed above in relation to FIG. 3. Again, the data processing circuit described above in relation to FIG. 3 may operate similar to that described above in relation to FIGS. 4-6 above. Examples of low priority data may include, but is not limited to, audio data or video data that when it includes errors is still playable and meaningful. In contrast, executable data or other data more sensitive to errors may be marked as high priority as they must be received without errors to assure that they operate properly. Based upon the disclosure provided herein, one of ordinary skill in the art will recognize a variety of different data types that may be identified as low priority and other data types that may be identified as high priority in accordance with different embodiments of the present invention. The received logical address is then converted to a physical address on the storage device, and an assembled write command including the data to be written and the physical write data address to which it is to be written is provided to the storage device (block 995). In turn, the storage device stores the provided write data.

Alternatively, where data is to be read from the storage device (block 905), a logical address for the data to be read is received (block 910), and a physical address corresponding to the logical address of the block of data to be read is prepared (block 915). The block of data to be read consists of a number of sub-blocks from which one of the sub-blocks is selected to be processed first (block 920). It is determined whether the selected sub-block is identified as high priority data (block 925). Where the selected sub-block is identified as high priority data (block 925), a read data priority output to the storage device is asserted to indicate a high priority (block 930). Alternatively, where the selected sub-block is identified as low priority data (block 925), a read data priority output to the storage device is asserted to indicate a low priority (block 935). The priority level of the sub-block is determined by accessing the priority data map that is updated as discussed above in relation to blocks 990, 995.

It is then determined whether another sub-block is to be read as part of the block of data to be read (block 940). Where another sub-block is to be read (block 940), the processes of blocks 925-940 are repeated for the next sub-block. Alternatively, where all of the sub-blocks of the data block to be read have been processed (block 940), an assembled read command including the physical address of the block of data to be read, and the read data priority information corresponding to each of the sub-blocks within the block of data to be read is provided to the storage device from which the data is to be accessed (block 945). The production of the read data by the storage device is then awaited (block 950). Once the requested block of read data is received (block 950), the data is used in accordance with the needs of the recipient device (block 955).

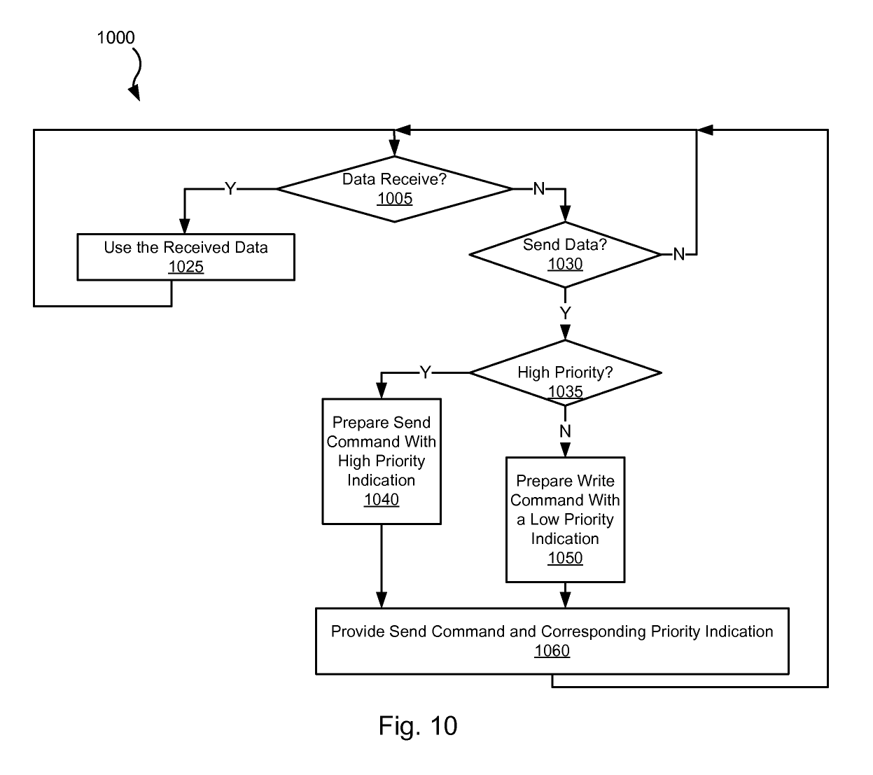

Turning to FIG. 10, a flow diagram 1000 shows a method for priority based access to a data transfer device in accordance with some embodiments of the present invention. Following flow diagram 1000, it is determined whether data is received (block 1005). Where data is received (1005), the received data is used by the recipient device in accordance with its needs (block 1025).

Alternatively, where data is not received (block 1005), it is determined whether data is to be sent (block 1030). Where data is to be sent (block 1030), it is determined whether the data to be sent is high priority data (block 1035). Where the data to be sent is high priority data (block 1035), a send command is prepared that indicates the data being sent is high priority data (block 1040). Alternatively, where the data to be sent is not high priority data (block 1035), a send command is prepared that indicates the data being sent is low priority data (block 1050). The send command including the priority indication and the data to be sent is then provided (block 1060).

It should be noted that the various blocks discussed in the above application may be implemented in integrated circuits along with other functionality. Such integrated circuits may include all of the functions of a given block, system or circuit, or a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for prioritizing data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A system, the system comprising:
a data transfer controller circuit operable to provide a read request to a storage device, wherein the read request indicates a data set to be provided from the storage device and a processing priority of at least a portion of the data set.

2. The system of claim 1, wherein the processing priority indicates a priority selected from a group consisting of: a high priority processing, and a low priority processing.

3. The system of claim 1, wherein the processing priority is selected based upon a type of data included in the portion of the data set.

4. The system of claim 1, wherein the processing priority indicates a priority selected from a group consisting of: a high priority processing and a low priority processing; wherein the processing priority is selected as the low priority processing when the portion of the data set is a first data type that is resilient to errors; and wherein the processing priority is selected as the high priority processing when the portion of the data set is a second data type that is not resilient to errors.

5. The system of claim 1, wherein the processing priority indicates a priority selected from a group consisting of: a high priority processing and a low priority processing; wherein the processing priority is selected as the high priority processing when the portion of the data set is of primary importance to the read request; and wherein the processing priority is selected as the low priority processing when the portion of the data set is of secondary importance to the read request.

6. The system of claim 1, wherein the data transfer controller circuit is implemented as part of a microprocessor based system including a microprocessor and a memory, wherein the memory includes instructions executable by the microprocessor to assign the processing priority.

7. The system of claim 6, wherein the microprocessor based system further comprises:
a priority data map operable to store the assigned processing priority in relation to the portion of the data set.

8. The system of claim 1, wherein the data transfer controller circuit is a memory access controller circuit, wherein the portion of the data set is a first portion of the data set, wherein the processing priority is a first processing priority, and wherein the system further comprises:
the storage device, wherein the storage device includes a storage medium and a data processing circuit, and wherein the data processing circuit includes:
an input buffer operable to maintain a first portion of the data set and a second portion of the data set, wherein the second portion of the data set is associated with a second processing priority;
a data detector circuit operable to apply a data detection algorithm to a selected data set to yield a detected output;
an external priority indication based scheduler circuit operable to:
receive the first processing priority and the second processing priority; and
select the first data set as the selected data set based at least in part on the first processing priority being higher than the second processing priority.

9. A system, the system comprising:
a data write controller circuit operable to provide a send request to a communication device, wherein the send request indicates a data set to be communicated by the communication device and a processing priority of at least a portion of the data set.

10. The system of claim 9, wherein the processing priority indicates a priority selected from a group consisting of: a high priority processing, and a low priority processing.

11. The system of claim 9, wherein the processing priority is selected based upon a type of data included in the portion of the data set.

12. The system of claim 9, wherein the processing priority indicates a priority selected from a group consisting of: a high priority and a low priority; wherein the processing priority is selected as the low priority processing when the portion of the data set is a first data type that is resilient to errors; and wherein the processing priority is selected as the high priority processing when the portion of the data set is a second data type that is not resilient to errors.

13. The system of claim 9, wherein the data write controller circuit is implemented as part of a microprocessor based system including a microprocessor and a memory, wherein the memory includes instructions executable by the microprocessor to assign the processing priority.

14. The system of claim 9, wherein the data set is a send data set, and wherein the system further comprises:
the communication device, wherein the communication device includes a transmitter and a receiver, wherein the receiver includes a data processing circuit that includes:
an input buffer operable to maintain a first received data set and a second received data set;
a data detector circuit operable to apply a data detection algorithm to a selected data set to yield a detected output;
an external priority indication based scheduler circuit operable to:
receive a first processing priority associated with the first received data set, and a second processing priority associated with the second received data set; and
select the first received data set as the selected data set based at least in part on the first processing priority being higher than the second processing priority.

15. A method for transferring data, the method comprising:
receiving a request to access information, wherein the request identifies a block of data to be accessed;
identifying a processing priority associated with at least a portion of the block of data; and
providing a transfer command that identifies the block of data and the processing priority.

16. The method of claim 15, wherein the processing priority indicates a priority selected from a group consisting of: a high priority processing and a low priority processing; wherein the processing priority is selected as the low priority processing when the portion of the block of data set is a first data type that is resilient to errors; and wherein the processing priority is selected as the high priority processing when the portion of the block of data is a second data type that is not resilient to errors.

17. The method of claim 15, wherein the processing priority indicates a priority selected from a group consisting of: a high priority processing and a low priority processing; wherein the processing priority is selected as the high priority processing when the portion of the block of data is of primary importance to the request to access information; and wherein the processing priority is selected as the low priority processing when the portion of the block of data of secondary importance to the request to access information.

18. The method of claim 15, wherein identifying the processing priority associated with at least a portion of the block of data includes accessing a priority data map operable to store the assigned processing priority in relation to the portion of the block of data.

19. A method for transferring data, the method comprising:
receiving a request to send information, wherein the request provides a block of data to be sent and indicates a type of data to be sent;
identifying a processing priority associated with the type of data to be sent; and
providing a send data set that includes the block of data to be sent and the processing priority.

20. The method of claim 19, wherein the processing priority indicates a priority selected from a group consisting of: a high priority processing and a low priority processing; wherein the processing priority is selected as the low priority processing when the type of data to be sent is a first data type that is resilient to errors; and wherein the processing priority is selected as the high priority processing when the type of data to be sent is a second data type that is not resilient to errors.

21. The method of claim 19, wherein the method further comprises:
receiving an input data set, wherein receiving the input data set includes:
receiving a first processing priority associated with a first received data set
storing the first received data set in an input buffer operable to maintain at least the first received data set and a second received data set, wherein the second received data set is associated with a second processing priority;
applying a data detection algorithm to a selected data set to yield a detected output;
selecting the first received data set as the selected data set based at least in part on the first processing priority being higher than the second processing priority; and
wherein the input data set is derived from the first received data set.
